(19) United States
(12) Patent Application Publication
(10) Pub. No.: US 2006/0140153 A1
(43) Pub. Date: Jun. 29, 2006

(54) Transmission data collection method and apparatus

(75) Inventors: Cheryl B. Heaser, Lake Zurich, IL (US); Jeffrey C. Smolinske, Schaumburg, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 11/025,411

(22) Filed: Dec. 29, 2004

(51) Int. Cl. H04Q 7/00

(52) U.S. Cl. 370/333

(57) ABSTRACT

A mobile station (16) operating under any cell reselection mode in a General Packet Radio Service (“GPRS”) standard generates (21) packet measurement data, receives (22) a request for the packet measurement data, and automatically sends (23) the packet measurement data to a base station (12) in response to receiving the request. The request message is generated from a maintenance center (11) that sends (31) the request to one or more base stations (12) that automatically send (32) the request to one or more mobile stations (16). When a base station (12) receives the packet measurement data from a mobile station (16), the base station (12) sends (35) the data to the maintenance center (11) where the data may be used to adjust (36) one or more wireless communication system settings.

### TECHNICAL FIELD

This invention relates generally to wireless communication systems and more particularly to systems that collect transmission data from mobile stations.

### BACKGROUND

Wireless communication systems of various kinds are known in the art. Many such systems typically include a method and apparatus to allow a mobile station, such as a mobile phone or other wireless communication device, to sense the quality of signal between it and one or more base stations. Mobile stations typically use such information for determining how to handle moving between cells.

Wireless communication systems will typically encounter any number of service problems through the normal course of operation. Such problems include, for example, areas of weakened signal, poor coverage, and cell reselection glitches. Users of a wireless communication system may notify the system operators of problems such that the operators may act to correct the problems. System operators, however, need information from the wireless communication system to properly address such problems or, alternatively, to detect and solve such problems before receiving customer complaints.

One source of information is data regarding the quality of signal between a mobile station and one or more base stations. Such information is known in the art and in many systems may generally be called measurement data or in certain systems packet measurement data. Mobile stations typically generate packet measurement data to assist in handling situations when mobile stations move between cells. This data, however, is not generally available to wireless communication system operators under certain system operation standards or certain mobile station configurations. For example, mobile stations operating under certain cell reselection modes in a General Packet Radio Service (“GPRS”) standard system will not transmit packet measurement data to a central location.

### BRIEF DESCRIPTION OF THE DRAWINGS

The above needs are at least partially met through provision of the transmission data collection method and apparatus described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention; and

FIG. 3 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, packet measurement data is generated at a mobile station operating under any mode in the GPRS standard. Then, the mobile station generating this data receives a request for packet measurement data. In response to receiving the request, the mobile station automatically sends packet measurement data to a base station. The data may then be forwarded to a maintenance center whereupon aspects of the wireless communication system may be adjusted using the packet measurement data from one or more mobile stations.

So configured, operators of a wireless communication system will have access to packet measurement data regardless of the cell reselection mode for the mobile stations operating under the GPRS standard. Such data will allow operators to fine tune the wireless communication system to improve coverage. Further, operators will be able to respond to specific complaints or problems by targeting certain mobile stations, cells, or base stations to receive the requests for packet measurement data to more efficiently address specific problems.

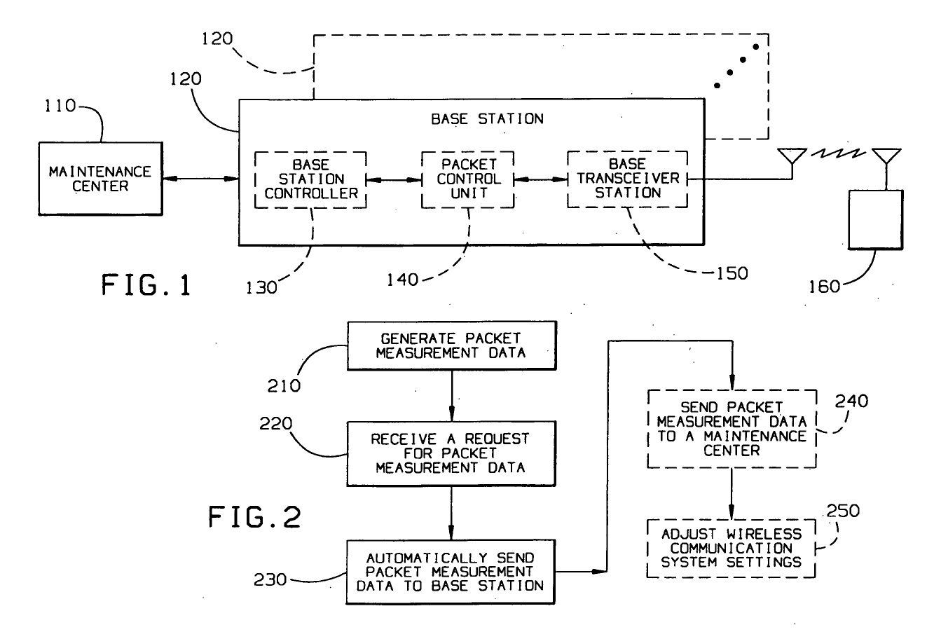

Referring now to the drawings, and in particular to FIG. 1, a maintenance center 110 is in communication with at least one base station 120. The base station 120 may optionally include a base station controller 130, a packet control unit 140, and a base transceiver station 150. The base station 120 is in wireless communication with at least one mobile station 160. The mobile stations 160 operate under any of the cell reselection modes available under the GPRS standard. It is known that mobile stations 160 operating under the GPRS standard generate and collect transmission information or packet measurement data, for example, to facilitate movement between cells. Such data is generated using known techniques and stored in a memory in the mobile station 160.

In various embodiments, the maintenance center 110 is a control center where signals can be generated for sending to base stations 120 and mobile stations 160. Such centers are known in the art, and these maintenance centers 110 are typically used to send various reprogramming related signals to base stations 120 or mobile stations 160. Alternatively, a maintenance center 110 may be a separate unit dedicated to addressing problems within a wireless communication system or for post-processing of the other data received from the system.

Pursuant to various embodiments, the mobile stations 160 are adapted to include one or more software routines or other enabling configurations that allow the mobile stations 160 to receive request messages for packet measurement data from a base station 120. Such software routines also allow the mobile stations 160 to automatically send the packet measurement data generated and stored by the mobile station 160 to the base station 120 in response to the receipt of a request.

The base station 120 is adapted to receive requests for packet measurement data from a maintenance center 110. In a preferred embodiment, the base station controller 130 is in communication with a maintenance center 110 such that it may receive requests for packet measurement data from the maintenance center and send packet measurement data to the maintenance center 110. The base station controller 130, in turn, is in communication with a packet control unit 140. The packet control unit 140 will take one or more requests for packet measurement data from the base station controller 130 and send the requests to the mobile stations 160 through the base transceiver station 150. Similarly, the packet control unit 140 will receive packet measurement data from the mobile stations 160 through the base transceiver station 150 and forward the data to the base station controller 140.

One skilled in the art will recognize that the form of the request message may change between the maintenance center 110 and the mobile station 160, but the effect is the same. Also, the base station controller 130, the packet control unit 140, and the base transceiver station 150 are known components that can be adapted for use in connection with the various embodiments. These components can also be separate structures or made integral.

A method of operation for collecting packet information data in accordance with these teachings will now be further described with reference to FIG. 2. First, a mobile station 160 generates 210 packet measurement data under any cell reselection mode in the GPRS standard. Then, the mobile station 160 receives 220 a request for packet measurement data. Next, the mobile station 160 automatically sends 230 the packet measurement data to a base station 120. Alternatively, the base station 120 may send 240 the packet measurement data to a maintenance center 110 where the data may be used to adjust 250 one or more wireless communication system settings.

One skilled in the art will recognize that the mobile station 160 can generate 210 packet measurement data in a number of ways. For example, the mobile station 160 may measure the relative signal strength among two or more base stations 120. The mobile station 160 may instead measure a magnitude of signal as received from a base station 120. Alternatively, the mobile station 160 may measure a ratio of desired signal to undesired signal. In another embodiment, the mobile station 160 may measure a bit error rate. Each of these measurements provides packet measurement data regarding the wireless transmissions of the mobile station 160.

This available packet measurement data can assist system operators to address certain system problems, and one skilled in the art will recognize that any number of adjustments to the wireless communication system can be made in response to receiving the packet measurement data. For example, one or more transmission resources, such as a radio frequency resource, may be reallocated using the packet measurement data. Further, the cell selection algorithm or parameters for one or more base stations 120 may be reprogrammed. Alternatively, a cell selection algorithm or parameters for one or more mobile stations 160 may be reprogrammed. For example, a request for packet measurement data can be generated and sent to a particular mobile station 160 that is experiencing a problem. The data received from the mobile station 160 can then be used to reprogram the cell selection algorithm or parameters for the mobile station 160 to improve its operation.

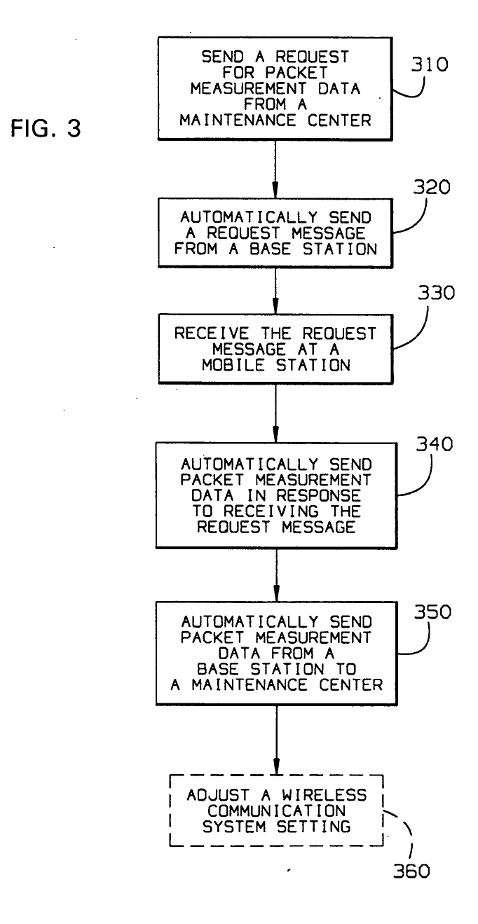

The operation of a wireless communication system in accordance with various embodiments will now be described in connection with FIG. 3. A maintenance center 110 sends 310 a request for packet measurement data. In response, a base station 120 sends 320 a request message corresponding to the request from the maintenance center to at least one mobile station 160. The mobile station 160 receives 330 the request message and automatically sends 340 packet measurement data in response to receiving the request message. The base station 120 receives the packet measurement data from the mobile station 160 and automatically sends 350 the packet measurement data to the maintenance center 110. Finally, one or more wireless communication system settings may be adjusted 360 in response to receiving the packet measurement data.

So configured, a wireless communication system operator at a maintenance center 110 can design the requests for data to address a specific problem. For example, a single maintenance center 110 may request data of every mobile station 160 operating within the coverage area of several base stations 120 where the wireless communication system's users are experiencing a number of problems. Once the data is collected from the mobile stations 160 through the various base stations 120, the data can be used to address the system's problem. Similarly, if a single user is experiencing problems, a system operator can use a maintenance center 110 to request packet measurement data from that user's mobile station 160 to analyze and address the problem.

Therefore, one skilled in the art will recognize various advantages in the various embodiments. The packet measurement data generated by mobile stations operating under the GPRS standard is more readily accessible regardless of the mobile stations' cell reselection mode. Also, the ability to tailor requests for data from a maintenance center 110 introduces flexibility and efficiency in collecting packet measurement data. This increased efficiency allows operators of a wireless communication system to better diagnose and correct problems within a wireless communication system.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
generating packet measurement data at a mobile station operating under any cell reselection mode in a General Packet Radio Service (GPRS) standard;
receiving at the mobile station a request for packet measurement data; and
automatically sending packet measurement data from the mobile station to a base station in response to receiving at the mobile station the request for packet measurement data.

2. The method of claim 1 wherein generating packet measurement data at a mobile station operating under any cell reselection mode in a GPRS standard further comprises measuring any one of:
a relative signal strength among two or more base stations;
a magnitude of signal;
a ratio of desired signal to undesired signal; and
a bit error rate.

3. The method of claim 1 further comprising:
sending the packet measurement data received at the base station to a maintenance center.

4. The method of claim 3 further comprising:
adjusting one or more wireless communication system settings in response to the packet measurement data received at the maintenance center.

5. The method of claim 4 wherein adjusting one or more wireless communication system settings in response to the packet measurement data received at the maintenance center further comprises any one of:
allocating at least one transmission resource;
programming a cell selection parameter at one or more base stations; and
programming a cell selection parameter at the mobile station.

6. A method comprising:
sending a request for packet measurement data from a maintenance center to at least one base station;
automatically sending from the at least one base station a request message that corresponds to the request for packet measurement data to at least one mobile station operating under any cell reselection mode in a General Packet Radio Service (GPRS) standard in response to receiving at the at least one base station the request for packet measurement data;
receiving at the at least one mobile station the request message;
automatically sending packet measurement data from the at least one mobile station to the at least one base station in response to receiving at the at least one mobile station the request message; and
automatically sending the packet measurement data from the at least one base station to the maintenance center in response to receiving the packet measurement data at the at least one base station.

7. The method of claim 6 wherein automatically sending packet measurement data from the at least one mobile station to the at least one base station in response to receiving at the at least one mobile station the request message further comprises sending a measurement of any one of:
a relative signal strength among two or more base stations;
a magnitude of signal;
a ratio of desired signal to undesired signal; and
a bit error rate.

8. The method of claim 6 wherein the request is sent in response to a problem in a wireless communication system.

9. The method of claim 8 further comprising:
adjusting at least one wireless communication system setting in response to the packet measurement data received at the maintenance center to attempt to correct the problem in the wireless communication system.

10. The method of claim 6 wherein automatically sending from the at least one base station a request message that corresponds to the request for packet measurement data to at least one mobile station operating under any cell reselection mode in a General Packet Radio Service (GPRS) standard in response to receiving at the at least one base station the request for packet measurement data further comprises automatically sending from the at least one base station the request message that corresponds to the request for packet measurement data to every mobile station operating under any cell reselection mode in a General Packet Radio Service (GPRS) standard in response to receiving at the at least one base station the request for packet measurement data

11. The method of claim 6 further comprising:
adjusting at least one wireless communication system setting in response to the packet measurement data received at the maintenance center.

12. The method of claim 11 wherein adjusting at least one wireless communication system setting in response to the packet measurement data received at the maintenance center further comprises any one of:
allocating at least one transmission resource;
programming a cell selection parameter at one or more base stations; and
programming a cell selection parameter at the mobile station.

13. An apparatus comprising:
a maintenance center;
one or more base stations in communication with the maintenance center, the one or more bases stations comprising means for receiving one or more requests for packet measurement data from the maintenance center and means for sending and receiving packet measurement data; and
one or more mobile stations operating under any cell reselection mode in a General Packet Radio Service (GPRS) standard in wireless communication with at least one of the one or more base stations, the one or more mobile stations comprising means for automatically sending packet measurement data to at least one of the one or more base stations in response to receiving the one or more requests for packet measurement data from the one or more base stations.

14. The apparatus of claim 13 wherein each of the one or more base stations in communication with the maintenance center further comprises:
a base station controller comprising means for receiving and sending packet measurement data and the one or more requests for packet measurement data; and
a packet control unit comprising means for receiving and sending packet measurement data and the one or more requests for packet measurement data;
a base transceiver station comprising means for receiving and sending packet measurement data and the one or more requests for packet measurement data.

15. The apparatus of claim 14 wherein the base station controller is in communication with the maintenance center and the packet control unit, and the packet control unit is in wireless communication with the one or more mobile stations via the base transceiver station.
